(19) United States
(12) Patent Application Publication
(10) Pub. No.: US 2020/0313505 A1
(43) Pub. Date: Oct. 1, 2020

(54) ELECTRIC OIL PUMP

(71) Applicant: NIDEC TOSOK CORPORATION, Kanagawa (JP)

(72) Inventors: Yoshiyuki KOBAYASHI, Kanagawa (JP); Shigehiro KATAOKA, Kanagawa (JP)

(73) Assignee: NIDEC TOSOK CORPORATION, Kanagawa (JP)

(21) Appl. No.: 16/830,223

(22) Filed: Mar. 25, 2020

(30) Foreign Application Priority Data
Mar. 29, 2019 (JP) 2019-069173
Feb. 25, 2020 (JP) 2020-029602

(51) Int. Cl. H02K 5/22; F04C 2/10

(52) U.S. Cl. CPC H02K 5/225; F04C 2/10; F04C 2240/40; F05B 2270/80; F04C 2240/81; F04C 2270/86; F05B 2270/326; H02K 2203/03

(57) ABSTRACT

An electric oil pump includes a pump part; a motor driving the pump part and having a rotor, a stator, and a motor shaft; a housing housing the motor; a control board including a drive circuit controlling driving of the motor; and a sensor board equipped with a rotation sensor detecting a rotation angle of the rotor of the motor. The motor shaft has one axial side connected to the pump part. The control board includes a sensor connection part performing electrical connection with the sensor board. The control board is arranged on a radially outer side with respect to the motor in a position of extending in an axial direction. The sensor board is arranged on the other axial side with respect to the motor shaft, and is arranged in a direction intersecting the axial direction.

### CROSS-REFERENCE TO RELATED APPLICATIONS

The present invention claims priority under 35 U.S.C. § 119 to Japanese Application No. 2019-069173, filed on Mar. 29, 2019, and Japanese Application No. 2020-029602, filed on Feb. 25, 2020, the entire content of which is incorporated herein by reference.

### FIELD OF THE INVENTION

The present disclosure relates to an electric oil pump.

### BACKGROUND

A conventional electric oil pump is known, which includes a pump part, a motor part for driving the pump part, a control board having a drive circuit for controlling the driving of the motor part, and a connector to which an external power supply is connected.

For example, an electric oil pump has been proposed, which includes the pump part, the motor part, the control board, and the connector described above. A motor of the motor part includes a main body having a rotor and a stator, and a shaft serving as a motor shaft. One axial side of the shaft protrudes from one axial side of the main body and is connected to the pump part.

The electric oil pump described above does not include a rotation sensor for detecting a rotation angle of the rotor, and in general, the control board controls the driving of the motor based on a detection result of the rotation angle obtained by the rotation sensor.

Another electric pump is known as a conventional technique that uses the detection result obtained by the rotation sensor for driving control of the motor. The electric pump includes a motor case serving as the main body, and a motor shaft in the motor part. One axial side of the motor shaft protrudes from one axial side of the motor case and is connected to the pump. The control board is fixed to the other axial side with respect to the stator, in a position that the board surface extends in the radial direction of the motor shaft, in the motor case. The rotation sensor is arranged in the motor case. The position where the rotation sensor is arranged in the motor case is between the stator and the control board in the axial direction.

Similar to the electric pump described above, the control board in the electric oil pump is also arranged in a position that the board surface extends in the radial direction of the motor shaft.

Since the control board protrudes largely outside the motor part in the radial direction, the electric oil pump and the electric pump described above both face the problem that they are large in size in the radial direction.

Further, when the rotation sensor is arranged in the same layout as the electric pump, the electric oil pump described above has the following problem. That is, in order to perform maintenance and inspection of the rotation sensor, the operator needs to remove the control board from the motor part to expose the rotation sensor to the outside, which is troublesome to the maintenance work of the rotation sensor.

Therefore, in order to save space in the radial direction and to improve the maintenance workability of the rotation sensor, it is conceivable to arrange the control board, which has the drive circuit for controlling the driving of the motor of the motor part, on the radially outer side with respect to the motor part in a position that the main surface of the control board extends in the axial direction of the motor, and arrange the sensor board for mounting the rotation sensor on the other axial side with respect to the other end of the motor shaft. Since the control board and the sensor board are separated from each other, the electrical connection between the control board and the rotation sensor board is realized via a harness, which hinders the assembly workability such as harness fixing processing after wiring.

### SUMMARY

According to an exemplary embodiment of the present disclosure, an electric oil pump includes: a pump part; a motor driving the pump part and including a rotor, a stator, and a motor shaft; a housing housing the motor; a control board including a drive circuit controlling driving of the motor; and a sensor board equipped with a rotation sensor detecting a rotation angle of the rotor of the motor. The motor shaft has one axial side connected to the pump part. The control board includes a sensor connection part performing electrical connection with the sensor board. The control board is arranged on a radially outer side with respect to the motor in a position of extending in an axial direction. The sensor board is arranged on the other axial side with respect to the motor shaft, and is arranged in a direction intersecting the axial direction. The sensor board is connected to a wiring module. The wiring module is arranged between the control board and the sensor board, and includes a sensor signal line and a sensor drive power supply line, and holds the sensor signal line and the sensor drive power supply line.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing an electric oil pump according to an exemplary embodiment of the present disclosure from the +Z side of an XYZ coordinate system (definition will be described later).

FIG. 2 is a perspective view showing the electric oil pump from the −Z side.

FIG. 3 is a cross-sectional view showing the X-Z cross-section of the electric oil pump at the position of a center axis J.

FIG. 4 is an exploded perspective view showing portions of the electric oil pump, excluding a housing, a motor cover, a pump cover, and an inverter cover, from the rear side in the axial direction (definitions of the front side and the rear side will be described later).

FIG. 5 is an exploded perspective view showing portions of the electric oil pump, excluding the housing, the motor cover, the pump cover, and the inverter cover, from the front side in the axial direction.

FIG. 6 is a partial perspective view showing the front side of a motor of the electric oil pump.

FIG. 7 is a perspective view showing the motor, portions in the housing of an inverter, and a rotation sensor from the front side in the axial direction.

FIG. 8 is a perspective view showing a U-phase bus bar, a W-phase bus bar, a V-phase bus bar, a control board, a first wiring unit, a second wiring unit, and a connector in the electric oil pump from the −Y side in the Y-axis direction.

FIG. 9 is a perspective view in which the illustration of a wiring holder of the first wiring unit in FIG. 8 is omitted, the illustration of a wiring holder of the second wiring unit in FIG. 8 is omitted, and the illustration of the bus bar in FIG. 8 is omitted.

FIG. 10 is a perspective view showing the control board, the first wiring unit, the second wiring unit, and the connector in the same state as FIG. 9 from the side opposite to FIG. 9.

FIG. 11 is a perspective view showing power input wirings and sensor wirings of a wiring module in the second wiring unit.

FIG. 12 is a circuit diagram of the control board.

FIG. 13 is a plan view showing a first surface of the control board.

FIG. 14 is a plan view showing a second surface of the control board.

FIG. 15 is a perspective view showing a mounting state of the wiring module in the electric oil pump.

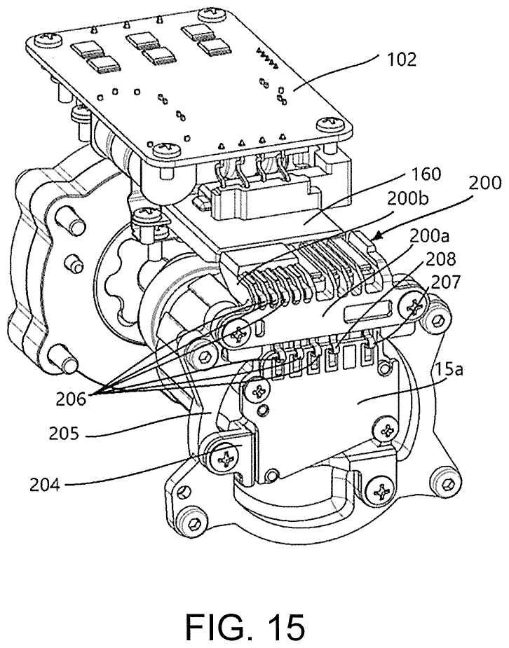

FIG. 16 is a perspective view showing a state where the housing omitted in FIG. 15 is present.

### DETAILED DESCRIPTION

Hereinafter, an electric oil pump according to an exemplary embodiment of the present disclosure will be described with reference to the drawings. In the present exemplary embodiment, the electric oil pump supplies oil to a transmission mounted on a vehicle such as an automobile. In the following drawings, the scale and number of the structures may be different from those of the actual structures to make the structures easier to understand.

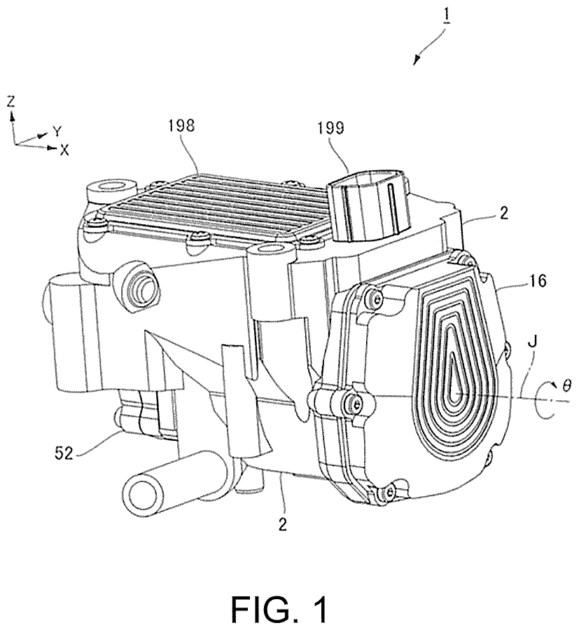

In the drawings, an XYZ coordinate system is shown appropriately as a three-dimensional orthogonal coordinate system. In the XYZ coordinate system, the X-axis direction is a direction parallel to the axial direction of a center axis J shown in FIG. 1. The center axis J is a center axis line of a shaft (motor shaft) 13 of a motor part 10 which will be described later. The Y-axis direction is a direction parallel to the transverse direction of the electric oil pump shown in FIG. 1. The Z-axis direction is a direction orthogonal to both the X-axis direction and the Y-axis direction. In any of the X-axis direction, the Y-axis direction, and the Z-axis direction, the side on which the arrow shown in the drawings points is the +side, and the opposite side is the −side.

In the following description, the positive side (+X side) in the X-axis direction is referred to as “rear side”, and the negative side (−X side) in the X-axis direction is referred to as “front side”. Nevertheless, the terms “rear side” and “front side” are simply names used for description, and are not intended to limit the actual positional relationship and direction. The front side (−X side) corresponds to one side in the present disclosure, and the rear side (+X side) corresponds to the other side in the present disclosure. Unless otherwise specified, the direction parallel to the center axis J (X-axis direction) is simply referred to as “axial direction”, the radial direction centered on the center axis J is simply referred to as “radial direction”, and the circumferential direction centered on the center axis J, that is, around the axis of the center axis J (θ direction), is simply referred to as “circumferential direction”.

In this specification, the phrase “extending in the axial direction” includes not only a case of extending strictly in the axial direction (X-axis direction), but also a case of extending in a direction inclined by less than 45° with respect to the axial direction. In this specification, the phrase “extending in the radial direction” includes not only a case of extending strictly in the radial direction, that is, a direction perpendicular to the axial direction (X-axis direction), but also a case of extending in a direction inclined by less than 45° with respect to the radial direction.

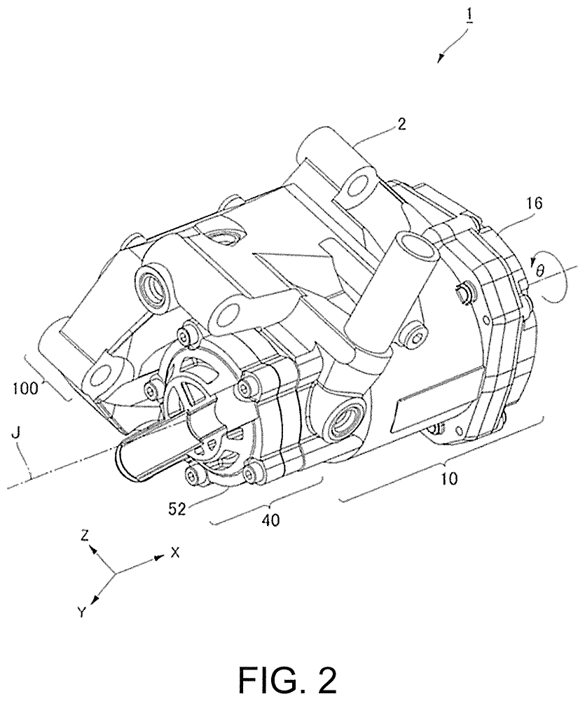

FIG. 1 is a perspective view showing the electric oil pump 1 according to an exemplary embodiment of the present disclosure from the +Z side. FIG. 2 is a perspective view showing the electric oil pump 1 from the −Z side. As shown in FIG. 2, the electric oil pump 1 includes a housing 2, a motor part 10, a pump part 40, and an inverter 100.

The housing 2 is a casting made of a metal (for example, a metal containing aluminum, magnesium, titanium, etc.) or a molded product made of a resin (also including a resin containing glass fiber, carbon, etc.). The housing 2 also serves as a motor housing for the motor part 10, a pump housing for the pump part 40, and an inverter housing for the inverter 100. The motor housing of the motor part 10, the pump housing of the pump part 40, and the inverter housing of the inverter 100 are portions of a single member.

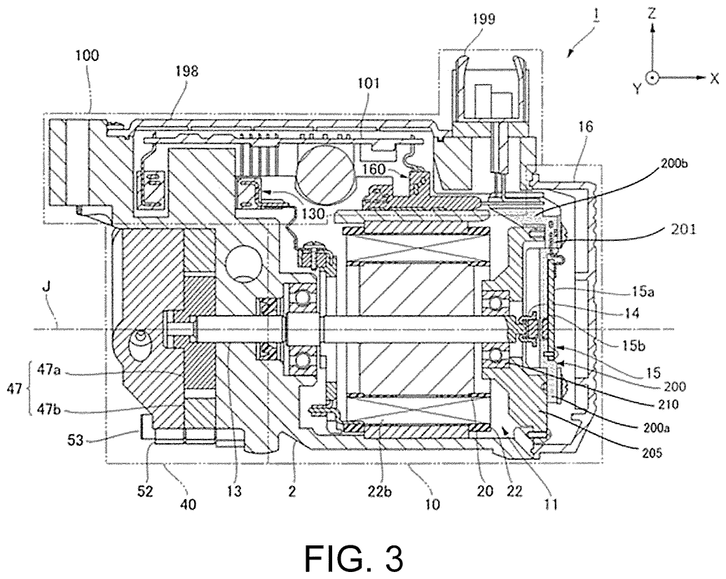

A rotor accommodating part accommodating a pump rotor (47 in FIG. 3) of the pump part 40 and the motor housing of the motor part 10 may be portions of a single member or may be separate bodies. Furthermore, the motor housing of the motor part 10 and the pump housing of the pump part 40 may be separate bodies.

When the motor housing and the pump housing are portions of a single member as in the electric oil pump 1 according to the exemplary embodiment, the boundary between the motor housing and the pump housing in the axial direction is defined as follows. That is, the axial center of a wall provided with a through hole, which allows the shaft (13 in FIG. 3) to pass through from inside the motor housing toward the rotor accommodating part of the pump housing, is the boundary between the two housings in the axial direction.

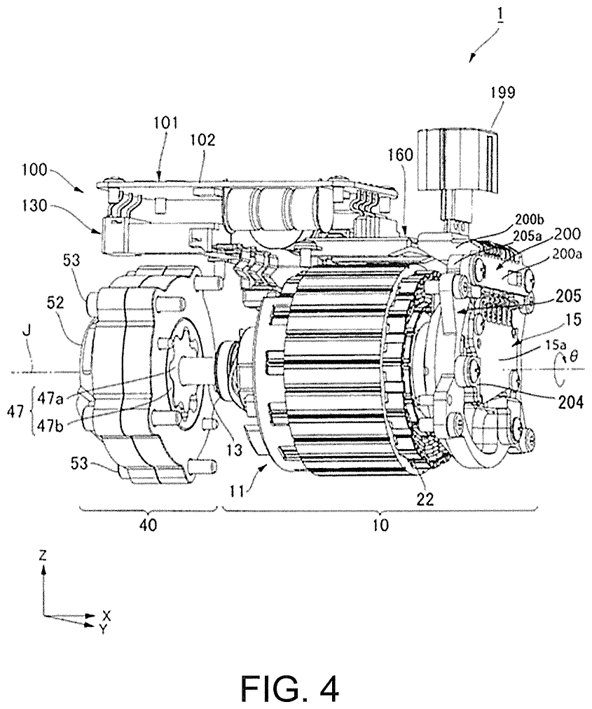

FIG. 3 is a cross-sectional view showing the X-Z cross-section of the electric oil pump at the position of the center axis J. FIG. 4 is an exploded perspective view showing portions of the electric oil pump 1, excluding the housing (2 in FIG. 1), the motor cover (16 in FIG. 1), the pump cover (52 in FIG. 1), and the inverter cover (198 in FIG. 1), from the rear side in the axial direction.

The motor part 10 includes a motor 11 in the motor housing.

The motor 11 includes a shaft 13 arranged along the center axis J extending in the axial direction, a sensor magnet 14, a rotation sensor 15, a motor cover 16, a rotor 20, and a stator 22. The sensor magnet 14, the motor cover 16, and the rotor 20 are shown only in FIG. 3 among FIG. 3 and FIG. 4.

The motor 11 is, for example, an inner rotor type motor. The rotor 20 is fixed to the outer peripheral surface of the shaft 13, and the stator 22 is arranged on the radially outer side of the rotor 20. The portion of the motor 11, excluding the shaft 13, is the main body of the motor 11. That is, the main body of the motor 11 is defined by the rotor 20, the stator 22, the sensor magnet 14, the rotation sensor 15, the motor cover 16, etc.

The rotor 20 is fixed to a region on the rear side (the other side) with respect to the axial center of the shaft 13 and to a region on the front side (one side) with respect to the end on the rear side. The stator 22 is arranged with the inner peripheral surface facing the outer peripheral surface of the rotor 20.

The axially front side of the shaft 13 that serves as the motor shaft protrudes from the end on the front side of the stator 22 to be connected to the pump part 40 (more specifically, a pump rotor 47 which will be described later).

The stator 22 includes a coil 22b. When power is supplied to the coil 22b, the shaft 13 and the rotor 20 fixed to the outer peripheral surface of the shaft 13 rotate.

As shown in FIG. 3, the sensor magnet 14 is fixed to the end on the axially rear side of the shaft 13 and rotates together with the shaft 13. The substantially disc-shaped sensor magnet 14 is bisected into two regions at the position of the diameter, and the magnetic pole in one region is the S pole and the magnetic pole in the other region is the N pole.

The rotation sensor 15 is fixed to the end on the rear side of the motor 11. Further, the rotation sensor 15 includes a sensor board 15a and an MR (Magnetic Resistance) element (magnetic sensor) 15b mounted on the sensor board 15a. The sensor board 15a is arranged in a direction intersecting the mounting surface of the magnetic sensor 15b in the axial direction. The angle of the intersection in the axial direction is not particularly limited, and may be, for example, 10° to 30°, preferably 30° to 45°, more preferably 45° to 60°, and even more preferably 60° to 75°, and an orthogonal angle in the range of 75° to 90° is highly preferable. The MR element 15b is located at a position where the center axis J passes, and faces the sensor magnet 14 in the axial direction. When the sensor magnet 14 rotates together with the shaft 13, the magnetic forces of the S pole and the N pole detected by the MR element 15b change. The MR element 15b outputs a first signal H1, a second signal H2, and a third signal H3 according to the detected magnetic forces. A microcomputer of the inverter 100 specifies the rotation angle of the shaft 13 based on the first signal H1, the second signal H2, and the third signal H3 sent from the MR element 15b.

The housing 2 has an opening facing the axially rear side at the end on the rear side in the axial direction. The motor cover 16 is fixed to the housing 2 and closes the above-mentioned opening. The operator is able to access the rotation sensor 15 of the motor 11 by removing the motor cover 16 from the housing 2.

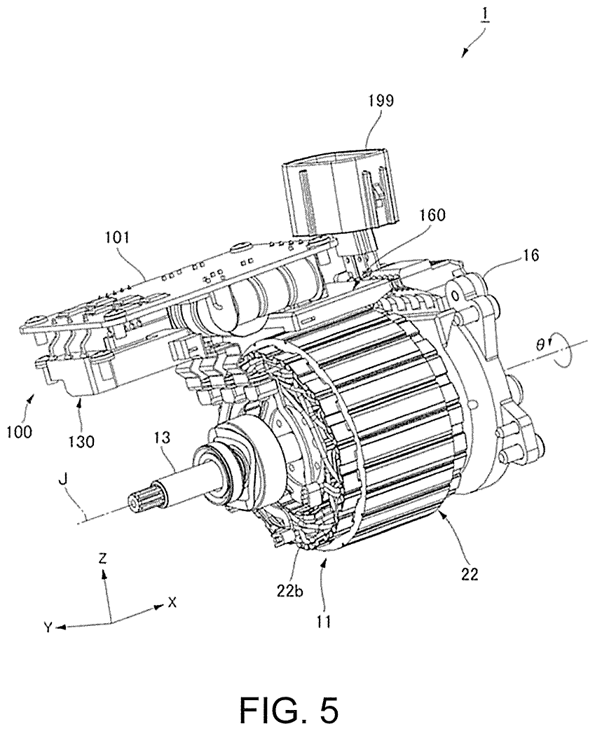

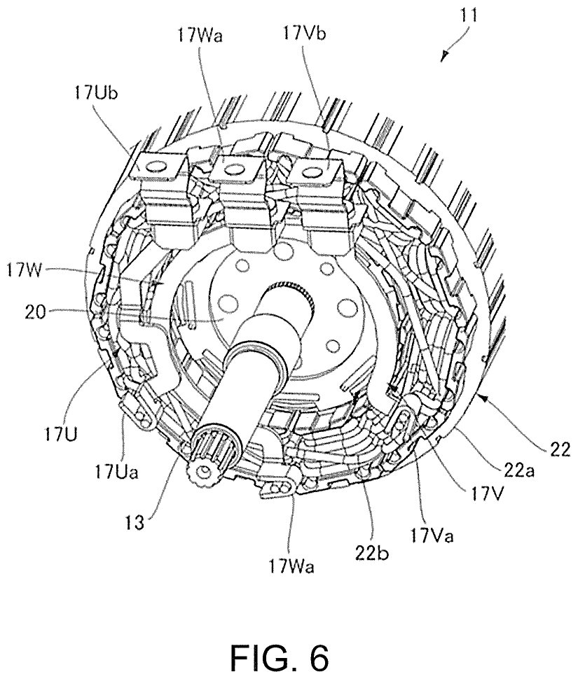

FIG. 5 is an exploded perspective view showing portions of the electric oil pump 1, excluding the housing (2), the motor cover (16), the pump cover (52), and the inverter cover (198), from the axially front side. FIG. 6 is a partial perspective view showing the front side of the motor 11. As shown in FIG. 6, the motor 11 includes a bus bar 17U, a bus bar 17W, and a bus bar 17V made of a metal such as copper. With respect to the bus bar 17U, the bus bar 17W, and the bus bar 17V, suffixes U, W, and V attached to the ends of the reference numerals indicate that they are members for the U phase, the W phase, and the V phase in the three-phase power supply. Hereinafter, U, W, and V shown in the drawings are merely exemplary, and are not intended to specify the positions of the members for the U phase, the V phase, and the W phase.

Each of the bus bars (17U, 17W, 17V) includes a caulking part (17Ua, 17Wa, 17Va) and a terminal (17Ub, 17Wb, 17Vb). A plurality of U-phase wires in the coil 22b are caulked by the caulking part 17Ua and are electrically connected to the bus bar 17U. A plurality of W-phase wires in the coil 22b are caulked by the caulking part 17Wa and are electrically connected to the bus bar 17W. A plurality of V-phase wires in the coil 22b are caulked by the caulking part 17Va and are electrically connected to the bus bar 17V.

The terminals (17Ub, 17Wb, 17Vb) of the bus bars (17U, 17W, 17V) are arranged on the axially front side of the main body that has the stator 22, etc. Specifically, the terminals (17Ub, 17Wb, 17Vb) are arranged on the axially front side with respect to the stator 22. The terminals (17Ub, 17Wb, 17Vb) are located between the stator 22 and the pump part 40 in the axial direction.

As shown in FIG. 4, the pump part 40 is located on the axially front side of the motor part 10, and is driven by the motor part 10 via the shaft 13 to discharge oil. The pump part 40 includes the pump rotor 47 and the pump cover 52.

The pump rotor 47 is attached to the front side of the shaft 13. The pump rotor 47 includes an inner rotor 47a and an outer rotor 47b. The inner rotor 47a is fixed to the shaft 13.

The outer rotor 47b surrounds the radially outer side of the inner rotor 47a.

The inner rotor 47a has an annular shape or a substantially annular shape. The inner rotor 47a is a gear having teeth on the radially outer side surface. The inner rotor 47a rotates around the axis (θ direction) together with the shaft 13. The outer rotor 47b has an annular shape or a substantially annular shape surrounding the radially outer side of the inner rotor 47a. The outer rotor 47b is a gear having teeth on the radially inner side surface. The radially outer side surface of the outer rotor 47b is circular or substantially circular.

The gear on the radially outer side surface of the inner rotor 47a and the gear on the radially inner side surface of the outer rotor 47b mesh with each other, and as the inner rotor 47a rotates with the rotation of the shaft 13, the outer rotor 47b rotates. That is, the rotation of the shaft 13 causes the pump rotor 47 to rotate. The motor part 10 and the pump part 40 are provided with the shaft 13 as a rotation shaft defined by the same member. Thereby, the size of the electric oil pump 1 in the axial direction is prevented from increasing.

Furthermore, as the inner rotor 47a and the outer rotor 47b rotate, the volume between the meshing portions of the inner rotor 47a and the outer rotor 47b changes. The region where the volume decreases is a pressurization region, and the region where the volume increases is a negative pressure region.

The housing 2 has an opening, facing the axially front side, at the end on the axially front side. This opening is closed by the pump cover 52. The pump cover 52 is fixed to the housing 2 by bolts 53.

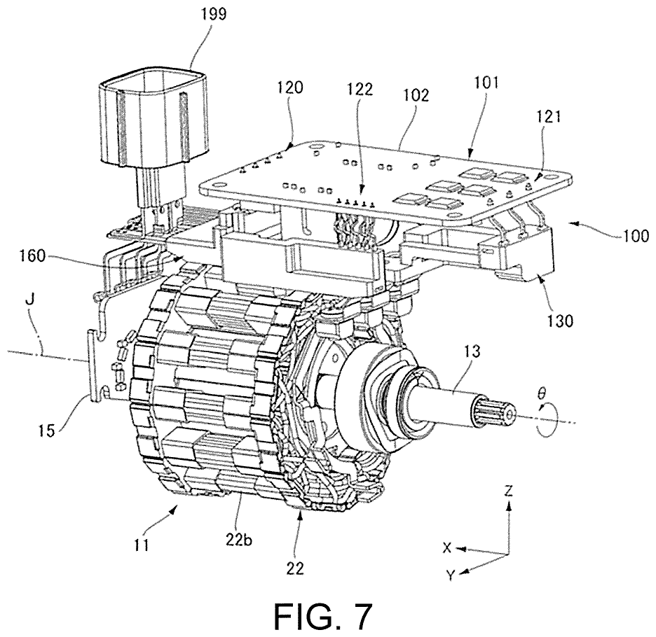

As shown in FIG. 4, the inverter 100 is arranged on the +Z side in the Z-axis direction with respect to the motor part 10 and the pump part 40. FIG. 7 is a perspective view showing the motor 11, the portions in the housing (2 in FIG. 2) of the inverter 100, and the rotation sensor 15 from the axially front side. In the figure, the illustration of the cylindrical core back (22a in FIG. 6) of the stator 22 in the motor 11 is omitted for convenience. The inverter 100 that controls the driving of the motor part 10 includes a control board 101, a first wiring unit 130, a second wiring unit 160, and a connector 199.

The control board 101 includes a board 102 and a plurality of electronic components mounted on the board 102. Part of the plurality of electronic components defines a motor drive circuit having an inverter function. The board 102 includes a sensor connection part 122, a power input part 120, and a motor power output part 121 electrically connected to wirings extending from the rotation sensor 15.

As shown in FIG. 4, the control board 101 is arranged on the radially outer side with respect to the motor part 10 in a position that any one of the two surfaces of the control board 101 extends in the axial direction. Since the first surface and the second surface of the control board 101 are parallel to each other, the shown control board 101 is arranged in a position that the two surfaces extend in the axial direction. The rotation sensor 15 is arranged on the axially rear side (+X side) with respect to the control board 101.

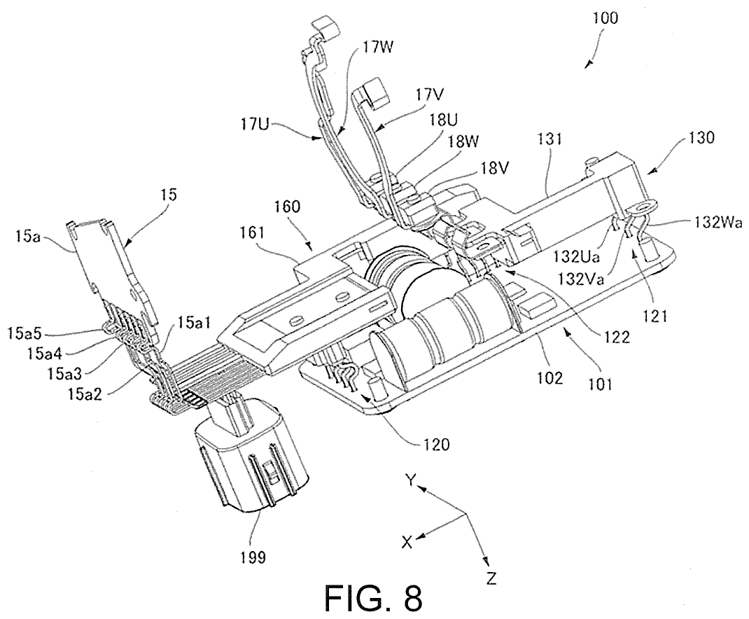

FIG. 8 is a perspective view showing the U-phase bus bar 17U, the W-phase bus bar 17W, the V-phase bus bar 17V, the control board 101, the first wiring unit 130, the second wiring unit 160, and the connector 199 from the −Y side in the Y-axis direction. The power input part 120 of the board 102 is provided at the end on the axially rear side of the board 102, and is electrically connected to each wiring of an ignition power supply of the vehicle. The motor power output part 121 is provided at the end on the axially front side of the board 102, and is electrically connected to each bus bar (17U, 17W, 17V) of the motor 11. The control board 101 converts DC power transmitted from the ignition power supply of the vehicle into three-phase AC power having a frequency according to a control signal transmitted from an ECU (Electronic Control Unit) of the vehicle, and outputs the three-phase AC power from the motor power output part 121 of the board 102. The sensor connection part 122 (in FIG. 7) is provided at the end on the +Y side in the Y-axis direction of the board 102 and at the center in the axial direction.

The first wiring unit 130 serves to electrically connect each bus bar (17U, 17W, 17V) of the motor 11 and the motor power output part 121 of the board 102. The second wiring unit 160 serves to electrically connect each terminal of the connector 199 and the power input part 120 of the board 102, and serves to electrically connect the rotation sensor 15 of the motor 11 and the sensor connection part (122 in FIG. 7) of the board 102. The first wiring unit 130 includes a wiring holder 131.

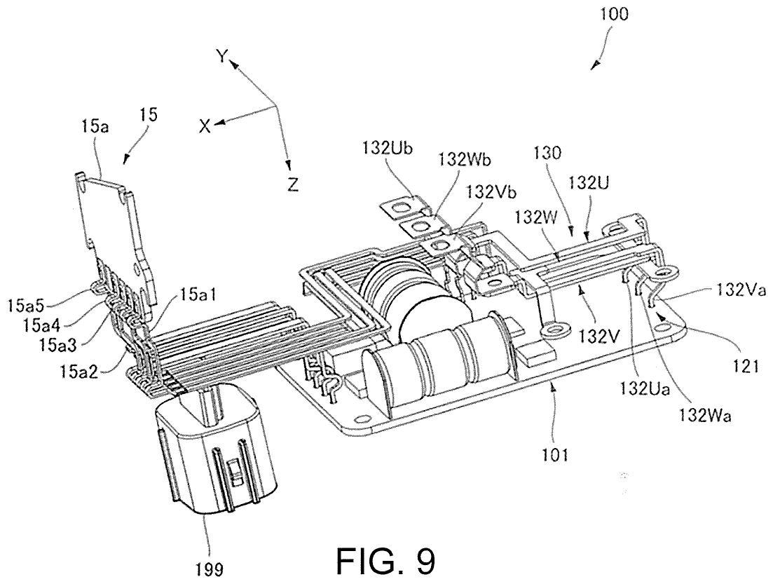

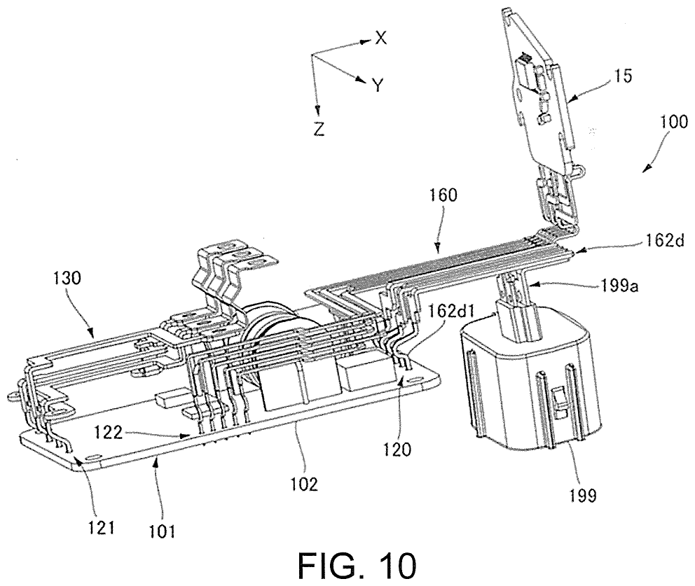

FIG. 9 is a perspective view in which the illustration of the wiring holder 131 of the first wiring unit 130 in FIG. 8 is omitted, the illustration of the first wiring holder 161 of the second wiring unit 160 in FIG. 8 is omitted, and the illustration of the bus bars (17U, 17W, 17V) in FIG. 8 is omitted. FIG. 10 is a perspective view showing the control board 101, the first wiring unit 130, the second wiring unit 160, and the connector 199 in the same state as FIG. 9 from the side opposite to FIG. 9.

As shown in FIG. 9, the first wiring unit 130 includes a U-phase power output wiring 132U, a W-phase power output wiring 132W, and a V-phase power output wiring 132V. The U-phase power output wiring 132U, the W-phase power output wiring 132W, and the V-phase power output wiring 132V all extend in the axial direction and are arranged at predetermined intervals in the Y-axis direction.

The U-phase power output wiring 132U includes an insertion part 132Ua provided at the end on the axially front side and a terminal part 132Ub provided at the end on the axially rear side. The central part of the U-phase power output wiring 132U in the axial direction extends in the axial direction. The end on the axially front side of the U-phase power output wiring 132U is bent toward the +Z side in the Z-axis direction, and the bent tip portion is the insertion part 132Ua. The end on the axially rear side of the U-phase power output wiring 132U is bent toward the +Z side in the Z-axis direction, and the bent tip portion is the terminal part 132Ub. The W-phase power output wiring 132W and the V-phase power output wiring 132V also include the same insertion parts (132Wa, 132Va) and terminal parts (132Wb, 132Vb) as the U-phase power output wiring 132U.

The insertion part 132Ua of the U-phase power output wiring 132 is soldered to a through hole and a land surrounding the through hole while being inserted into the U-phase through hole in the motor power output part 121 of the board 102. Both the inner peripheral surface of the through hole and the land are made of an electrically conductive material such as copper. Similar to the insertion part 132Ua of the U-phase power output wiring 132U, the insertion part 132Wa of the W-phase power output wiring 132W and the insertion part 132Va of the V-phase power output wiring 132V are also soldered while being inserted into the W-phase and V-phase through holes of the motor power output part 121 of the board 102.

The terminal part 132Ub of the U-phase power output wiring 132U is fixed to a U-phase terminal block (18U in FIG. 8) fixed to the terminal of the U-phase bus bar 17U by a screw or the like while overlapping the terminal (17Ub in FIG. 6) of the U-phase bus bar 17U in the Z-axis direction. Similar to the terminal of the U-phase power output wiring 132U, the terminal part 132Wb of the W-phase power output wiring 132W and the terminal part 132Vb of the V-phase power output wiring 132V are also fixed to the terminal blocks (18W, 18V in FIG. 8). The method of fixing the terminal (132Ub, 132Wb, 132Vb) of the power output wiring of each phase to the terminal block (18U, 18W, 18V in FIG. 8) is not limited to screwing. For example, the terminal part of the power output wiring and the terminal of the bus bar may be fixed to the terminal block by applying thermal energy, or the terminal part and the terminal may be connected using the metal characteristics without using a fixture.

The U-phase power output wiring 132U electrically connects the terminal (17Ub in FIG. 6) of the U-phase bus bar 17U and the motor power output part 121 of the board 102 by soldering the insertion part 132Ua and fixing the terminal part 132Ub to the terminal block (18U in FIG. 8). The W-phase power output wiring 132W electrically connects the terminal (17Wb in FIG. 6) of the W-phase bus bar 17W and the motor power output part 121 of the board 102 by soldering the insertion part 132Wa and fixing the terminal part 132Wb to the terminal block (18W in FIG. 8). The V-phase power output wiring 132V electrically connects the terminal (17Vb in FIG. 6) of the V-phase bus bar 17V and the motor power output part 121 of the board 102 by soldering the insertion part 132Va and fixing the terminal part 132Vb to the terminal block (18V in FIG. 8).

The U-phase power output wiring 132U, the W-phase power output wiring 132W, and the V-phase power output wiring 132V are all made of a metal plate such as a copper plate. Hereinafter, the U-phase power output wiring 132U, the W-phase power output wiring 132W, and the V-phase power output wiring 132V are collectively referred to as the power output wiring 132 of each phase.

The wiring holder (131 in FIG. 8) of the first wiring unit 130 is made of a resin or the like, and holds the central part in the axial direction of each of the U-phase power output wiring 132, the W-phase power output wiring 132W, and the V-phase power output wiring 132V in a state of being defined into a predetermined shape.

The first wiring unit 130 is arranged between the first surface of the board 102 and the pump part 40, as shown in FIG. 4.

The connector 199 is connected to an external ignition power supply connector. The ignition power supply connector has four ports for constant power supply, GND, CAN-Lo signal, and CAN-Hi signal, and is moved from the +Z side to the −Z side in the Z-axis direction by the operator to be mounted on the connector 199. As shown in FIG. 10, the connector 199 includes a terminal part 199a having four connector terminals that are individually electrically connected to the four ports of the ignition power supply. The four connector terminals are arranged side by side along the Y-axis direction in a position of extending in the axial direction.

In the Y-axis direction, the connector terminal for constant power supply is located closest to the +Y side among the four connector terminals. In the Y-axis direction, the connector terminal for GND is located closest to the −Y side among the four connector terminals. In the Y-axis direction, the connector terminal for CAN-Lo signal and the connector terminal for CAN-Hi signal are located between the connector terminal for constant power supply and the connector terminal for GND.

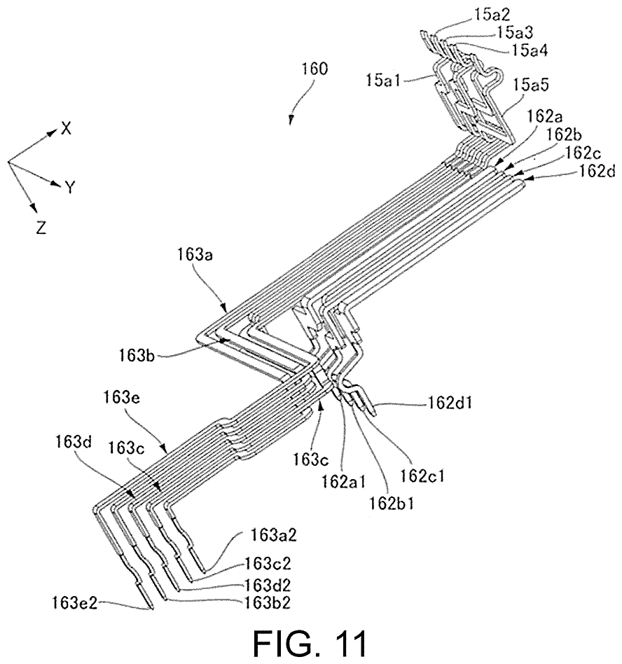

As shown in FIG. 8, the second wiring unit 160 includes the first wiring holder 161. FIG. 11 is a perspective view showing power input wirings and sensor wirings in the second wiring unit 160. The second wiring unit 160 is provided with four power input wirings, which include a first power input wiring 162a, a second power input wiring 162b, a third power input wiring 162c, and a fourth power input wiring 162d. The second wiring unit 160 is provided with five sensor wirings, which include a first sensor wiring 163a, a second sensor wiring 163b, a third sensor wiring 163c, a fourth sensor wiring 163d, and a fifth sensor wiring 163e. Hereinafter, the first to fourth power input wirings are collectively referred to as the four power input wirings 162. In addition, the first to fifth sensor wirings are collectively referred to as the five sensor wirings 163.

The four power input wirings 162 and the five sensor wirings 163 are both made of a metal plate such as a copper plate. On the axially rear side of the inverter 100, the four power input wirings 162 and the five sensor wirings 163 are arranged side by side along the Y-axis direction in a position of extending in the axial direction. The four power input wirings 162 are arranged in the order of the first (162a), the second (162b), the third (162c), and the fourth (162d) from the −Y side to the +Y side along the Y-axis direction at the positions on the axially rear side of the inverter 100. The five sensor wirings 163 are arranged in the order of the first (163a), the second (163b), the third (163c), the fourth (163d), and the fifth (163e) from the −Y side to the +Y side in the Y-axis direction at the positions on the axially rear side of the inverter 100. At the positions on the axially rear side of the inverter 100, the four power input wirings 162 are located on the +Y side in the Y-axis direction with respect to the five sensor wirings 163.

Nevertheless, the order of arrangement of the four power input wirings 162 in the Y direction is not limited to the order described above, and may be any order. Also, the order of arrangement of the five sensor wirings 163 in the Y-axis direction is not limited to the order described above, and may be any order.

The connector terminal for constant power supply in the terminal part 199a of the connector 199 shown in FIG. 10 is soldered or welded to the first power input wiring 162a for constant power supply among the four power input wirings 162 shown in FIG. 11. The connector terminal for GND in the terminal part 199a of the connector 199 shown in FIG. 10 is soldered or welded to the fourth power input wiring 162d for GND among the four power input wirings 162 shown in FIG. 11. The connector terminal for CAN-Lo signal in the terminal part 199a of the connector 199 shown in FIG. 10 is soldered or welded to the second power input wiring 162b for CAN-Lo signal among the four power input wirings 162 shown in FIG. 11. The connector terminal for CAN-Hi signal in the terminal part 199a of the connector 199 shown in FIG. 10 is soldered or welded to the third power input wiring 162c for CAN-Hi signal among the four power input wirings 162 shown in FIG. 11.

As shown in FIG. 11, the four power input wirings 162 respectively include insertion parts (162a1, 162b2, 162c1, 162d1) having the same structure. The end on the axially front side of each of the four power input wirings 162 is bent toward the +Z side in the Z-axis direction, and the bent tip is the insertion part (162a1, 162b2, 162c1, and 162d1).

In FIG. 10, the power input part 120 of the board 102 includes four sets of through holes and lands surrounding the through holes. The above-described four sets are connection parts that are electrically connected independently to the mutually different connector terminals, and are arranged side by side along the Y-axis direction.

The insertion part (162a1 in FIG. 11) of the first power input wiring 162a for constant power supply is soldered to the through hole and the land surrounding the through hole while being inserted into the through hole for constant power supply in the power input part 120 of the board 102. Both the inner peripheral surface of the through hole and the land are made of an electrically conductive material such as copper. The insertion part (162d1 in FIG. 11) of the fourth power input wiring 162d for GND is soldered to the through hole and the land for GND in the power input part 120 of the board 102. The insertion part (162b1 in FIG. 11) of the second power input wiring 162b for CAN-Lo signal is soldered to the through hole and the land for CAN-Lo signal in the power input part 120 of the board 102. The insertion part (162c1 in FIG. 11) of the third power input wiring 162c for CAN-Hi signal is soldered to the through hole and the land for CAN-Hi signal in the power input part 120 of the board 102.

As described above, mutually different connector terminals are individually soldered or welded to the portions on the axially rear side of the four power input wirings 162. Also, the insertion parts (162a1, 162b2, 162c1, and 162d1 in FIG. 11) of the four power input wirings 162 are individually soldered to mutually different sets of through holes and lands in the power input part 120 of the board 102. With such a configuration, the four power input wirings 162 electrically connect the connector terminal of the connector 199 and the power input part of the control board 101.

The length of each of the five sensor wirings 163 in the axial direction is greater than the length of each of the four power input wirings 162 in the axial direction.

As shown in FIG. 9 and FIG. 11, the sensor board 15a includes a sensor terminal 15a1 that outputs a first signal H1, a sensor terminal 15a2 that is connected to GND, and a sensor terminal 15a3 that outputs a second signal H2. In addition, the sensor board 15a includes a sensor terminal 15a4 that outputs a third signal H3, and a sensor terminal 15a5 that is connected to a 5V power supply. That is, the sensor board 15a includes five sensor terminals.

Each of the five sensor terminals protrudes from the board surface of the sensor board 15a toward the +Z side in the Z-axis direction, and then bends at an angle of about 90° toward the axially front side. Then, the bent tip is connected to the sensor wiring (163) of the second wiring unit 160. The above-described connection is realized by welding or soldering. In the axial direction, the ends on the rear side of the five sensor wirings 163 are located at the same position as the ends on the rear side of the four power input wirings 162. Each of the five sensor terminals is connected to the end on the axially rear side of the sensor wiring 163. Each of the five sensor terminals is made of an electrically conductive material such as copper.

An insertion part (163a2, 163b2, 163c2, 163d2, 163e2) is provided at the end on the axially front side of each of the five sensor wirings 163. The end on the axially front side of each of the five sensor wirings 163 is bent toward the +Z side in the Z direction, and the bent tip is the insertion part (163a2, 163b2, 163c2, 163d2, 163e2).

Among the five sensor wirings 163, the first sensor wiring 163a is a wiring for the first signal H1. The second sensor wiring 163b is a wiring for GND. The third sensor wiring 163c is a wiring for the second signal H2. The fourth sensor wiring 163d is a wiring for the third signal H3. The fifth sensor wiring 163e is a wiring for the 5V power supply.

Nevertheless, the order of arrangement of the five sensor wirings 163 in the Y-axis direction is not limited to the order described above, and may be any order.

In the five sensor wirings 163, the portions excluding the insertion parts (163a2, 163b2, 163c2, 163d2, 163e2) extend in the axial direction.

Each of the five sensor wirings 163 has a shape that the portion on the axially front side with respect to the four power input wirings 162 is bent in a complicated manner. Hereinafter, the position where the sensor wiring 163 is first bent from the axially rear side toward the axially front side is referred to as the “bending starting point”.

The axially rear side of the fifth sensor wiring 163e for the 5V power supply is located fifth in the Y-axis direction, among the five sensor wirings 163, when counted from the −Y side. The fifth sensor wiring 163e for the 5V power supply is bent toward the +Y side in the Y-axis direction at the “bending starting point”, and then bent toward the front side in the axial direction. Further, immediately after being bent to the −Y side in the Y-axis direction, it is bent to the front side in the axial direction. Hereinafter, for the five sensor wirings 163, the state where the sensor wiring is bent to the front side in the axial direction immediately after being bent to the −Y side in the Y-axis direction, as described above, is referred to as being bent in a crank shape. The fifth sensor wiring 163e is bent in the complicated manner as described above so that the insertion part 163e2 which will be described later faces the sensor connection part (122 in FIG. 10) of the board 102 in the Z-axis direction.

The axially rear side of the second sensor wiring 163b for GND is located second in the Y-axis direction, among the five sensor wirings 163, when counted from the −Y side. The “bending starting point” of the second sensor wiring 163b for GND is located on the axially front side with respect to the “bending starting point” of the fifth sensor wiring 163e. The second sensor wiring 163b is bent toward the +Y side in the Y-axis direction at the “bending starting point”, and then slightly bent toward the +Z side in the Z-axis direction. Thereafter, the second sensor wiring 163b is bent toward the +Y side in the Y-axis direction and reaches the position facing the fifth sensor wiring 163e in the Z-axis direction. At this position, the second sensor wiring 163b is bent toward the front side in the axial direction, and then, similar to the fifth sensor wiring 163e, the second sensor wiring 163b is bent in a crank shape while facing the fifth sensor wiring 163e in the Z-axis direction. The second sensor wiring 163b is bent in the complicated manner as described above so that the insertion part 163b2 which will be described later faces the sensor connection part (122 in FIG. 10) of the board 102 at a position on the +Z side with respect to the fifth sensor wiring 163e in the Z-axis direction.

The axially rear side of the third sensor wiring 163c for the second signal H2 is located third in the Y-axis direction, among the five sensor wirings 163, when counted from the −Y side. The “bending starting point” of the third sensor wiring 163c for the second signal H2 is located on the axially rear side with respect to the “bending starting point” of the fifth sensor wiring 163e. The third sensor wiring 163c is slightly bent toward the +Z side in the Z-axis direction at the “bending starting point”, and then slightly bent toward the front side in the axial direction.

Thereafter, the third sensor wiring 163c is bent toward the +Y side in the Y-axis direction, and faces the fifth sensor wiring 163e for the 5V power supply in the Z-axis direction. Further, the third sensor wiring 163c is bent toward the +Z side in the Z-axis direction, and then bent toward the +Y side in the Y-axis direction. Thereafter, the third sensor wiring 163c is bent toward the axially front side, and then, similar to the fifth sensor wiring 163e, the third sensor wiring 163c is bent in a crank shape. The third sensor wiring 163c is bent in the complicated manner as described above so that the insertion part 163c2 which will be described later faces the sensor connection part (122 in FIG. 10) of the board 102 in the Z-axis direction.

The axially rear side of the fourth sensor wiring 163d for the third signal H3 is located fourth in the Y-axis direction, among the five sensor wirings 163, when counted from the −Y side. The “bending starting point” of the fourth sensor wiring 163d and the “bending starting point” of the third sensor wiring 163c are at the same position in the axial direction. The fourth sensor wiring 163d is bent to the +Z side in the Z-axis direction at the “bending starting point”, and then bent to the axially front side and three-dimensionally crosses the third sensor wiring 163c on the +Z side. Thereafter, at a position facing the second sensor wiring 163b in the Z-axis direction, the fourth sensor wiring 163d is bent to the +Y side in the Y-axis direction. Then, the fourth sensor wiring 163d is bent to the axially front side at a position facing (entering between) both the second sensor wiring 163b and the third sensor wiring 163c in the Z-axis direction. Further, similar to the fifth sensor wiring 163e, the fourth sensor wiring 163d is bent in a crank shape. The fourth sensor wiring 163d is bent in the complicated manner as described above so that the insertion part 163d2 which will be described later faces the sensor connection part (122 in FIG. 10) of the board 102 in the Z-axis direction.

The axially rear side of the first sensor wiring 163a for the first signal H1 is located first in the Y-axis direction, among the five sensor wirings 163, when counted from the −Y side. The “bending starting point” of the first sensor wiring 163a is located on the axially front side with respect to the “bending starting point” of the second sensor wiring 163b. The first sensor wiring 163a is bent to the +Y side in the Y-axis direction at the “bending starting point”, and then bent to the +Z side in the Z-axis direction. Thereafter, the first sensor wiring 163a is bent to the +Y side in the Y-axis direction, and then bent to the axially front side at a position facing the third sensor wiring 163c in the Z-axis direction. Further, similar to the fifth sensor wiring 163e, the first sensor wiring 163a is bent in a crank shape. The first sensor wiring 163a is bent in the complicated manner as described above so that the insertion part 163a2 which will be described later faces the sensor connection part (122 in FIG. 10) of the board 102 in the Z-axis direction.

The portions bent in a crank shape as described above in the five sensor wirings 163 are located at the same position in the axial direction and overlap each other in the Z-axis direction.

In the vicinity of the sensor connection part (122 in FIG. 10) of the board 102, the portions, which extend in the axial direction, of the five sensor wirings 163 are arranged side by side in the Z-axis direction which is along the thickness direction of the board 102. The order of arrangement of the above-described portions in the Z-axis direction is, from the −Z side to the +Z side, the fifth sensor wiring 163e, the second sensor wiring 163b, the fourth sensor wiring 163d, the third sensor wiring 163c, and the first sensor wiring 163a.

In FIG. 10, the sensor connection part 122 of the board 102 includes five sets of through holes and lands surrounding the through holes. The above-described five sets are arranged side by side in the order of the set for the 5V power supply, the set for GND, the set for the third signal H3, the set for the second signal H2, and the set for the first signal H2, from the front side to the rear side in the axial direction. Hereinafter, the arrangement order of the through holes and the sets of the through holes and the lands from the front side to the rear side in the axial direction is simply referred to as the arrangement order.

As shown in FIG. 11, the end on the axially front side of the fifth sensor wiring 163e for the 5V power supply is bent toward the +Z side in the Z-axis direction at a position on the front side with respect to the second sensor wiring 163b for GND. The insertion part 163e2, which is the bent tip portion, is inserted into the through hole for the 5V power supply located first in the arrangement order, among the five through holes of the sensor connection part (122 in FIG. 10) of the board 102, without interfering with any of the other four sensor wirings. Then, the insertion part 163e2 is soldered to the set of the through hole and the land for the 5V power supply.

The end on the axially front side of the second sensor wiring 163b for GND is bent toward the +Z side along the Z-axis direction at a position on the rear side with respect to the fifth sensor wiring 163e in the axial direction and on the front side with respect to the fourth sensor wiring 163d in the axial direction. The insertion part 163b2, which is the bent tip portion, is inserted into the through hole for GND located second in the arrangement order, among the five through holes provided in the sensor connection part (122 in FIG. 10) of the board 102, without interfering with any of the other four sensor wirings. Then, the insertion part 163b2 is soldered to the set of the through hole and the land for GND.

The end on the axially front side of the fourth sensor wiring 163d for the third signal H3 is bent toward the +Z side in the Z-axis direction. The position of the bending in the axial direction is a position on the rear side with respect to the second sensor wiring 163b and on the front side with respect to the third sensor wiring 163c. The insertion part 163d2, which is the bent tip portion, is inserted into the through hole for the third signal H3 located third in the arrangement order, among the five through holes provided in the sensor connection part (122 in FIG. 10) of the board 102, without interfering with any of the other four sensor wirings. Then, the insertion part 163d2 is soldered to the set of the through hole and the land for the third signal H3.

The end on the axially front side of the third sensor wiring 163c for the second signal H2 is bent toward the +Z side in the Z-axis direction. The position of the bending in the axial direction is a position on the rear side with respect to the fourth sensor wiring 163d and on the front side with respect to the first sensor wiring 163a. The insertion part 163c2, which is the bent tip portion, is inserted into the through hole for the second signal H2 located fourth in the arrangement order, among the five through holes of the sensor connection part (122 in FIG. 10) of the board 102, without interfering with any of the other four sensor wirings. Then, the insertion part 163c2 is soldered to the set of the through hole and the land for the second signal H2.

The end on the axially front side of the first sensor wiring 163a for the first signal H1 is bent toward the +Z side in the Z-axis direction. The position of the bending in the axial direction is a position on the rear side with respect to the third sensor wiring 163c. The insertion part 163a2, which is the bent tip portion, is inserted into the through hole for the first signal H1 located fifth in the arrangement order, among the five through holes of the sensor connection part (122 in FIG. 10) of the board 102, without interfering with any of the other four sensor wirings. Then, the insertion part 163a2 is soldered to the set of the through hole and the land for the first signal H1.

As described above, the axially rear sides of the five sensor wirings 163 of the second wiring unit 160 are connected to the sensor terminals (15a1 to 15a5) of the sensor board 15a. In addition, the respective insertion parts (163a2, 163b2, 163c2, 163d2, 163e2) of the five sensor wirings 163 are individually soldered to the mutually different sets of through holes and lands in the sensor connection part 122 of the board 102. With such a configuration, the five sensor wirings 163 electrically connect the rotation sensor 15 and the sensor connection part 122 of the board 102 of the control board 101.

In FIG. 8, the first wiring holder 161 of the second wiring unit 160 is made of a resin or the like, and is defined into a predetermined shape. The axially rear side of the first wiring holder 161 of the second wiring unit 160 holds the four power input wirings 162 and the five sensor wirings 163. In each of the four power input wirings 162, the connection part with the connector terminal and the insertion part (162a1, 162b1, 162c1, 162d1 in FIG. 11) are not held by the first wiring holder 161. Further, in each of the five sensor wirings 163, the insertion part (163a2, 163b2, 163c2, 163d2, 163e2 in FIG. 11) is not held by the first wiring holder 161.

The four sets of through holes and lands in the power input part 120 of the board 102 are arranged on the board 102 in a form of being arranged side by side in the Y-axis direction along the radial direction. The plurality of connector terminals of the connector 199 are arranged in a form of being arranged side by side in the same direction as the four sets of through holes and lands of the power input part 120. The five sensor terminals (15a1 to 15a5) of the sensor board 15a are arranged on the sensor board 15a in a form of being arranged side by side in the same direction as the four sets of through holes and lands of the power input part 120.

The first wiring holder 161 of the second wiring unit 160 holds the four power input wirings 162 and the five sensor wirings 163 on the axially rear side in a form that they are arranged side by side in the same direction as the arrangement direction of the sets of through holes and lands of the power input part 120 of the board 102.

As shown in FIG. 10, the sensor connection part 122 of the board 102 is arranged between the power input part 120 and the motor power output part 121 in the axial direction.

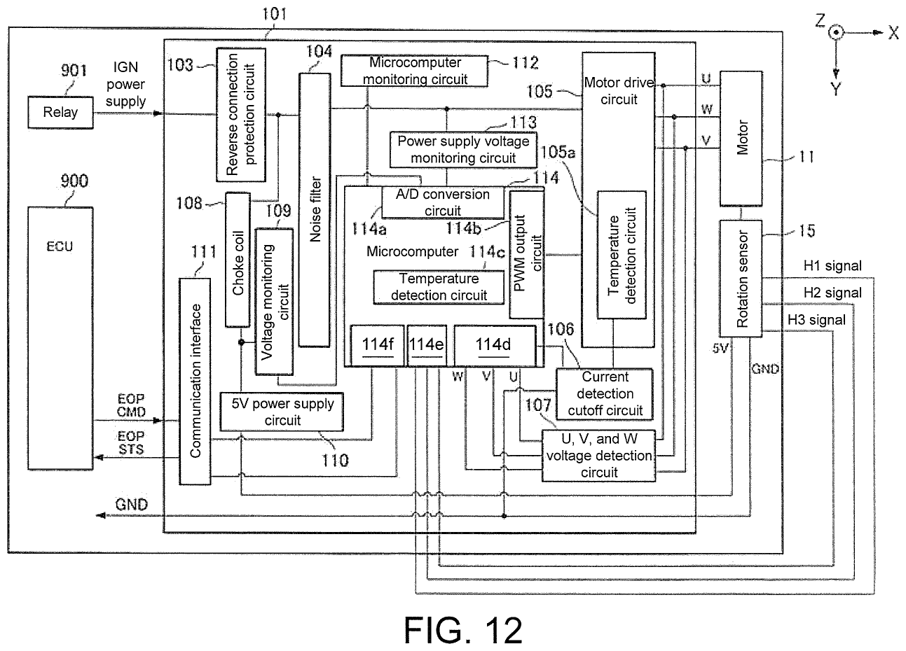

FIG. 12 is a circuit diagram of the control board 101 of the inverter 100. The control board 101 includes a reverse connection protection circuit 103, a noise filter 104, a motor drive circuit 105, a current detection cutoff circuit 106, a U, V, and W voltage detection circuit 107, a choke coil 108, and a voltage monitoring circuit 109. In addition, the control board 101 includes a 5V power supply circuit 110, a communication interface 111, a microcomputer monitoring circuit 112, a power supply voltage monitoring circuit 113, and a microcomputer 114.

An ignition (IGN) power supply is connected to the power input part (120 in FIG. 10) of the board 102 of the control board 101 via a relay 901 of the vehicle. The constant power supply of the ignition power supply and GND are connected to the motor drive circuit 105 via the reverse connection protection circuit 103 and the noise filter 104 for removing noise.

The reverse connection protection circuit 103 is a circuit for preventing a reverse current from flowing to the downstream side when the constant power supply of the ignition power supply and GND are connected in reverse.

The power supply voltage monitoring circuit 113 is connected to a wiring that electrically connects the noise filter 104 and the motor drive circuit 105. The power supply voltage monitoring circuit 113 detects a DC voltage output from the noise filter 104 to the motor drive circuit 105, and outputs the detected value to an A/D conversion circuit 114a of the microcomputer 114.

The microcomputer 114 includes the A/D conversion circuit 114a, a PWM output circuit 114b, a temperature detection circuit 114c, an A/D conversion circuit 114d, an I/O circuit 114e, and a communication circuit 114f. The microcomputer 114 receives a control signal transmitted from the ECU 900 of the vehicle via the communication interface 111 of the control board 101 by the communication circuit 114f, and generates a PWM signal for driving the motor 11 to rotate at a frequency based on the control signal. The generated PWM signal is output from the PWM output circuit 114b of the microcomputer 114 and is input to the motor drive circuit 105.

The motor drive circuit 105 converts the DC power transmitted from the noise filter 104 into three-phase AC power having a frequency according to the PWM signal transmitted from the PWM output circuit 114b of the microcomputer 114, and outputs the three-phase AC power to the motor 11. The motor drive circuit 105 includes a plurality of bipolar transistors for switching (MOS-FETs (Metal Oxide Semiconductor Field Effect Transistors)), and a temperature detection circuit 105a. The temperature detection circuit 105a of the motor drive circuit 105 outputs the detected temperature value to the current detection cutoff circuit 106.

The current detection cutoff circuit 106 detects the current flowing from the motor drive circuit 105 to the motor 11. When the detected current value exceeds a predetermined upper limit, or when the detected temperature value transmitted from the temperature detection circuit 105a of the motor drive circuit 105 exceeds a predetermined upper limit, the current detection cutoff circuit 106 outputs a cutoff signal to the microcomputer 114.

When the cutoff signal is transmitted from the current detection cutoff circuit 106, or when the temperature value detected by the temperature detection circuit 114c of the microcomputer 114 exceeds a predetermined upper limit, the microcomputer 114 stops the generation of the PWM signal to stop the driving of the motor 11.

The U, V, and W voltage detection circuit 107 detects the voltage of the three-phase AC power output from the motor drive circuit 105 to the motor 11, and outputs the detected value to the A/D conversion circuit 114d of the microcomputer 114.

The 5V power supply circuit 110 is connected to a wiring that electrically connects the reverse connection protection circuit 103 and the noise filter 104 via the choke coil 108. The choke coil 108 defines a circuit for preventing the current flowing through the 5V power supply circuit 110 from becoming an overcurrent. The 5V power supply circuit 110 outputs a 5V power supply to the rotation sensor 15.

The microcomputer monitoring circuit 112 is connected to the microcomputer 114, and monitors the microcomputer 114 for abnormalities by communicating with the microcomputer 114.

The voltage monitoring circuit 109 detects the voltage of the DC power transmitted from the choke coil 108 to the 5V power supply circuit 110, and outputs the detected value to the A/D conversion circuit 114a of the microcomputer 114.

The first signal H1, the second signal H2, and the third signal output from the rotation sensor 15 are input to the I/O circuit 114e of the microcomputer 114. The microcomputer 114 specifies the rotation angle of the rotor (20 in FIG. 3) of the motor 11 based on the first signal H1, the second signal H2, and the third signal H3, and calculates the rotation frequency of the rotor based on the specified result.

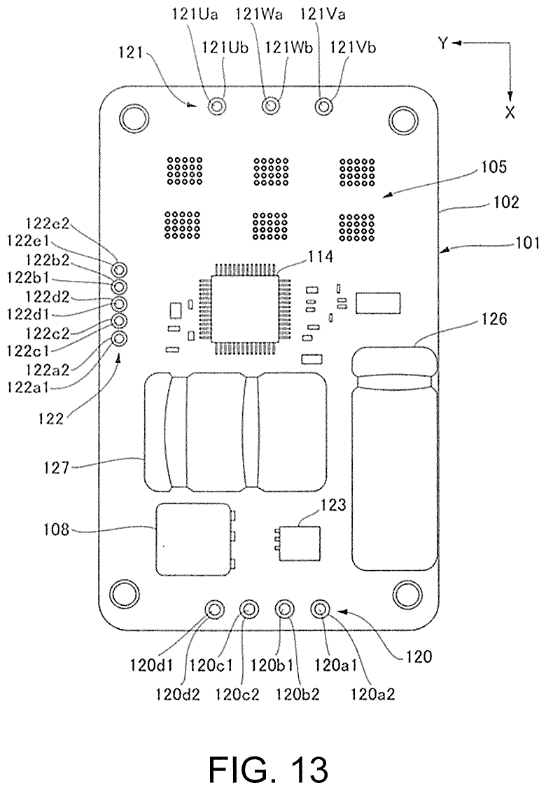

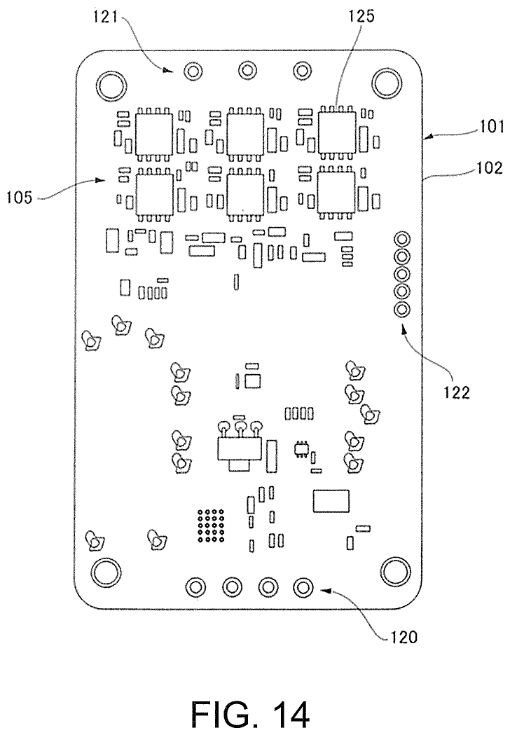

FIG. 13 is a plan view showing the first surface of the control board 101. FIG. 14 is a plan view showing the second surface of the control board 101. The power input part 120 arranged at the end on the axially rear side (+X side) of the board 102 of the control board 101 includes four sets of through holes and lands. The first set includes the through hole 120a1 and the land 120a2 for constant power supply. The second set includes the through hole 120b1 and the land 120b2 for CAN-Lo signal. The third set includes the through hole 120c1 and the land 120c2 for CAN-Hi signal. The fourth set includes the through hole 120d1 and the land 120d2 for GND. The above-described four sets are connection parts individually electrically connected to the four connector terminals of the connector (199 in FIG. 10), and are arranged side by side along the Y-axis direction.

The choke coil 108, the bipolar transistor 123 defining the reverse connection protection circuit (103 in FIG. 12), a first capacitor 126, and a second capacitor 127 are mounted in the region on the rear side (−X side) with respect to the power input part 120 of the board 102 in the axial direction. The first capacitor 126 and the second capacitor 127 are electronic components defining the noise filter (104 in FIG. 12). The second capacitor 127 is an electronic component having the largest thickness (the size in the thickness direction of the board 102) among a plurality of electronic components mounted on the board 102. Further, the second capacitor 127 is arranged on the front side with respect to the choke coil 108 and the bipolar transistor 123 in the axial direction.

The sensor connection part 122 is provided and the microcomputer 114 is mounted in the region on the rear side with respect to the first capacitor 126 and the second capacitor 127 of the board 102 in the axial direction. The sensor connection part 122 includes five sets of through holes and lands. The first set includes the through hole 122a1 and the land 122a2 for the first signal H1. The second set includes the through hole 122c1 and the land 122c2 for the second signal H2. The third set includes the through hole 122d1 and the land 122d2 for the third signal H3. The fourth set includes the through hole 122b1 and the land 122b2 for GND. The fifth set includes the through hole 122e1 and the land 122e2 for the 5V power supply. The above-described five sets are arranged side by side along the axial direction at the end of the board 102 in the Y-axis direction.

Six bipolar transistors 125 are mounted in the region on the rear side with respect to the microcomputer 114 and the sensor connection part 122 of the board 102 in the axial direction. The above-described six bipolar transistors 125 define a portion of the motor drive circuit 105.

On the board 102, the region on the axially rear side with respect to the six bipolar transistors 125 is the end on the rear side of the board 102. The motor power output part 121 is arranged at the end on the rear side. The motor power output part 121 includes three sets of through holes and lands. The first set includes the through hole 121Ua and the land 121Ub for the U phase of the three-phase AC power. The second set includes the through hole 121Wa and the land 121Wb for the W phase. The third set includes the through hole 121Va and the land 121Vb for the V phase. Each of the above-described three sets is an individual output part that outputs power having a different phase.

As shown in FIG. 13, the second capacitor 127 having the largest thickness among a plurality of electronic components mounted on the board 102 is mounted on the first surface of the board 102. As shown in FIG. 4, the control board 101 is arranged in a position that the first surface, which is the surface for mounting the second capacitor (127 in FIG. 13) among the first surface and the second surface of the board 102, faces the side of the motor part 10.

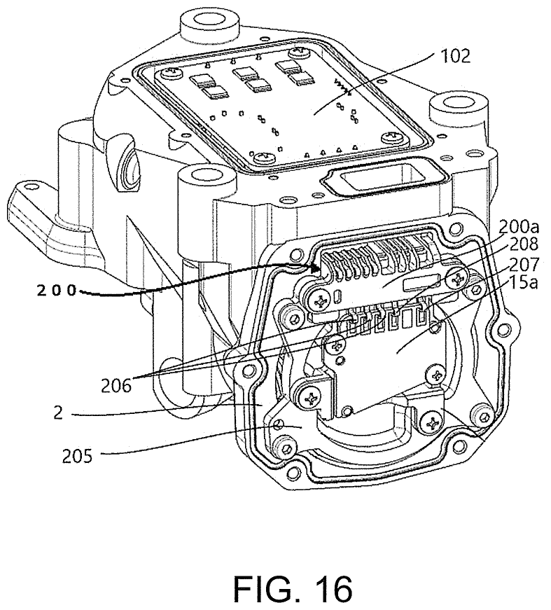

As shown in FIG. 3, FIG. 4, and FIG. 16, a wiring module 200 is fixed to the housing 2. The wiring module 200 may be fixed to a bearing holder 205 that defines the housing 2.

A bearing 210 is supported by the housing 2 or the bearing holder 205.

In addition, the sensor board 15a is fixed to the wiring module 200 with screws.

The wiring module 200 includes a power line 208 and a ground line 207, a plurality of sensor signal lines 206, and a wiring holder 201 of the wiring module 200 integrally resin-molding the power line 208, the ground line 207, and the plurality of sensor signal lines 206.

The power line 208 and the ground line 207 inserted into the wiring module 200 and the plurality of sensor signal lines 206 pass through the second wiring unit 160 and are connected to the control board 101.

The sensor board 15a is fixed to the wiring module 200, and each of the sensor signal lines 206, the power line 208, and the ground line 207 of the wiring module 200 is soldered to the electrical connection portion of the sensor board 15a on the radially center axis side. In addition, the connection between the electrical connection portion of the sensor board 15a and the sensor signal lines 206, the power line 208, and the ground line 207 of the wiring module 200 is not limited to soldering, and may be fixed by applying thermal energy, or they may be connected using the metal characteristics of the sensor signal lines 206, the power line 208, and the ground line 207.

Each of the sensor signal lines 206, the power line 208, and the ground line 207 of the wiring module 200 is soldered to the second wiring unit 160 on the radially outer side. In addition, the connection between the second wiring unit 160 and the sensor signal lines 206, the power line 208, and the ground line 207 of the wiring module 200 is not limited to soldering, and may be fixed by applying thermal energy, or they may be connected using the metal characteristics of the sensor signal lines 206, the power line 208, and the ground line 207.

Hereinafter, the terminal 17Ub of the bus bar 17U, the terminal 17Wb of the bus bar 17W, and the terminal 17Vb of the bus bar 17V shown in FIG. 8 are collectively referred to as the “bus bar terminal”. Further, the insertion part 132Ua of the U-phase power output wiring 132U, the insertion part 132Wa of the W-phase power output wiring 132W, and the insertion part 132Va of the V-phase power output wiring 132V are collectively referred to as the “power output wiring insertion part”. In addition, the terminal part 132Ub of the U-phase power output wiring 132U, the terminal part 132Wb of the W-phase power output wiring 132W, and the terminal part 132Vb of the V-phase power output wiring 132V are collectively referred to as the “power output wiring terminal part”.

(1) The electric oil pump 1 includes the pump part 40, the motor part 10 driving the pump part 40, the control board 101 having the motor drive circuit 105 controlling the driving of the motor 11 of the motor part 10, and the connector 199 to which the ignition power supply serving as an external power supply is connected. The motor 11 includes the main body having the rotor 20 and the stator 22, and the shaft 13 serving as the motor shaft. The front side of the shaft 13 in the axial direction protrudes from the axially front side of the main body, and is connected to the pump part 40. The main body of the motor part 10 includes the rotation sensor 15 detecting the rotation angle of the rotor 20. The control board 101 includes the sensor connection part 122 electrically connected to the rotation sensor 15, the power input part 120, and the motor power output part 121, and is arranged on the radially outer side with respect to the motor part 10 in a position that the first surface, among the first surface and the second surface of the control board 101, extends in the axial direction. The rotation sensor 15 is arranged on the axially rear side with respect to the control board 101. The power input part 120 is arranged at the end on the axially rear side of the control board 101. The main body of the motor 11 includes the second wiring unit 160 that electrically connects the control board 101 and the connector 199 and the rotation sensor 15. The second wiring unit 160 includes the four power input wirings 162, the five sensor wirings 163, and the first wiring holder 161. The four power input wirings 162 connect the terminals of the terminal part 199a of the connector 199 and the power input part 120 of the control board 101. The five sensor wirings 163 connect the rotation sensor 15 and the sensor connection part 122 of the control board 101. The first wiring holder 161 is defined into a predetermined shape, and holds the four power input wirings 162 and the five sensor wirings 163.

In the electric oil pump 1 having such a configuration, the installation space of the control board 101 arranged on the outer side with respect to the motor part 10 in the radial direction remains at a value obtained by adding the thickness of the board 102 and the thickness of the electronic components mounted on the board 102. The electric oil pump 1 having such a configuration is different from the conventional configuration in which the control board 101 is arranged in a position that the board surface of the control board 101 extends in the radial direction, and the control board 101 does not protrude largely to the outer side of the motor part 10 in the radial direction. Therefore, according to the electric oil pump 1, space saving is achieved.

Besides, in the electric oil pump 1, the rotation sensor 15 arranged on the axially rear side with respect to the control board 101 is not covered by the control board 101. The operator is able to perform maintenance and inspection of the rotation sensor 15 without removing the control board 101 from the electric oil pump 1. Therefore, according to the electric oil pump 1, the maintenance workability is improved.

In the electric oil pump 1, it is easy for the operator to perform the electrical connection operation by using the second wiring unit 160.

Furthermore, in the electric oil pump 1, the second wiring unit 160 integrally holds the four power input wirings 162 and the five sensor wirings 163 with the first wiring holder 161. Thus, the electric oil pump 1 saves wiring space as compared with a configuration in which the four power input wirings 162 and the five sensor wirings 163 are held individually.

(2) The rotation sensor 15 of the electric oil pump 1 includes the sensor board 15a on which electronic components are mounted. The sensor board 15a is arranged at the end on the axially rear side of the main body of the motor 11 so that any one of the two surfaces of the sensor board 15a extends in the radial direction and intersects the axial direction.

In the electric oil pump 1, the installation space of the rotation sensor 15 in the axial direction remains at a value obtained by adding the thickness of the sensor board 15a and the thickness of the electronic components mounted on the sensor board 15a. Therefore, according to the electric oil pump 1, the size of the main body of the motor 11 in the axial direction is reduced as compared with a configuration in which the sensor board 15a is arranged in a position that the board surface of the sensor board 15a extends in the axial direction.

(3) The wiring module 200 is arranged on the other axial side with respect to the end on the other axial side of the control board 101.

According to such a configuration, the sensor board 15a on which the rotation sensor 15 is arranged is small in the radial direction, and the terminal part 199a of the connector 199 is accommodated in the region of the corner defined by the extended surface of the surface of the control board 101 and the extended surface of the surface of the sensor board 15a, and the amount of protrusion of the connector 199 in the radial or the axial direction is suppressed, so the electric oil pump device is downsized.

(4) The convex part of the wiring module 200 is inserted into the concave part of the sensor board 15a for positioning.

According to such a configuration, the sensor board 15a is easily mounted to the wiring module 200 without an error in the mounting direction. In addition, the positioning concave/convex parts also prevent rotation in the circumferential direction, so that a shift in the circumferential direction during screw fixing is suppressed, and the electrical connection portion between the sensor signal lines 206, the ground line 207, and the power line 208 and the sensor board 15a is stabilized. In addition, since the sensor board 15a does not shift in the circumferential direction, the position accuracy detected by the rotation sensor 15 is improved.

(5) The wiring module 200 is made of a resin or the like, and has the wiring holder 201 defined by a first region 200b, etc. and holds the five sensor terminals (15a1 to 15a5) with the wiring holder 201. Since each of the five sensor terminals protrudes from the board surface of the sensor board 15a to the +Z side in the Z-axis direction and then bends at an angle of about 90° toward the axially front side, the wiring module 200 having the five sensor terminals and the wiring holder 201 includes the first region 200b extending in the axial direction, and a second region 200a which is connected to the first region and bends to extend to the motor shaft side. The wiring module 200 is fixed to the housing 2 or the bearing holder 205 defining the housing 2 by screws. A collar member is integrally defined or press-fitted into a mounting portion where the wiring holder 201 of the wiring module 200 is mounted to the bearing holder 205, and is fixed to the bearing holder 205 after screws pass through the collar member. Further, the bearing holder 205 holds the bearing on the other axial side by press-fitting, inserting, or inserting and bonding, and the bearing is fitted with the shaft 13 serving as the motor shaft. The end surface of the shaft 13 is present on the other axial side with respect to the bearing, and the sensor magnet 14 is fixed to the end surface of the shaft 13.

According to such a configuration, the path from the sensor board 15a to the control board 101 is arranged compactly to connect the sensor board and the control board according to the position of the control board 101, which prevents the connection portion from becoming large and contributes to downsizing the entire electric oil pump. In addition, since the sensor board 15a is fixed to the wiring module 200 in the state of holding the sensor terminals, the assembly workability when connecting the sensor terminals and the sensor board 15a is favorable. Then, the wiring module 200 is able to be fixed without causing a shift with respect to the motor 11. Furthermore, the bearing holder 205 is provided with the bearing supporting the rotation shaft, the shaft 13 fixed to the bearing, and the sensor magnet 14 fixed to the shaft 13, and is provided with the wiring module 200 to which the sensor board 15a is fixed. That is, by integrating the rotation angle read side and the rotation angle reading side into the bearing holder 205, as the axial shift in the radial direction is reduced, the distance between the rotation angle read side and the rotation angle reading side in the axial direction is shortened. As a result, the detection accuracy of the rotation sensor 15 is improved. Also, by applying, for example, a metal collar member to the portion where the wiring module 200 is mounted to the bearing holder 205, there is no permanent distortion or shape change due to aging even under the stress caused by screw tightening, and the reliability of quality of detection accuracy is enhanced.

(6) The control board 101 of the electric oil pump 1 includes the board 102 and electronic components mounted on the board 102. The five sensor wirings 163 and the four power input wirings 162 are made of a metal plate. The connector 199 is held by the four power input wirings 162.

According to the electric oil pump 1 having such a configuration, the four power input wirings 162 made of a metal plate are also used as the holder for holding the connector 199, which achieves space saving and cost reduction.

(7) The connector 199 of the electric oil pump 1 includes four terminals independent of each other on the terminal part 199a. The power input part 120 of the control board 101 includes four connection parts (sets of through holes and lands) that are electrically connected to the four terminals of the connector 199 independently of each other. The sensor board 15a includes five sensor terminals (15a1 to 15a5) electrically connected to the control board 101. The sensor connection part 122 of the control board 101 includes five connection parts (sets of through holes and lands) that are individually electrically connected to the five sensor terminals (15a1 to 15a5) connected to the sensor board 15a. The second wiring unit 160 includes the four power input wirings 162 that individually connect the four connection parts in the power input part 120 of the control board 101 and the four terminals in the terminal part 199a of the connector 199, and the five sensor wirings 163 that individually connect the sensor terminals (15a1 to 15a5) connected to the rotation sensor 15 and the five connection parts in the sensor connection part 122 of the control board 101. The first wiring holder 161 of the second wiring unit 160 holds the four power input wirings 162 and the five sensor wirings 163 on the axially rear side by regulating their movements.

In the electric oil pump 1 having such a configuration, the first wiring holder 161 of the second wiring unit 160 holds the four power input wirings and the five sensor wirings without movement. Thus, according to the electric oil pump 1, the electrical connection workability between each of the above-mentioned wirings and the power input part 120 of the control board 101, and the sensor connection part 122 is improved, and the productivity of the electric oil pump 1 is improved.

(8) The four connection parts (sets of through holes and lands) in the power input part 120 of the electric oil pump 1 are arranged on the control board 101 in a form of being arranged side by side in the direction along the surface of the board 102 of the control board 101. The four terminals in the terminal part 199a of the connector 199 are arranged in a form of being arranged side by side in the same direction as the four connection parts of the power input part 120. The five sensor terminals (15a1 to 15a5) connected to the sensor board 15a are arranged on the sensor board 15a in a form of being arranged side by side in the same direction as the four connection parts of the power input part 120. The first wiring holder 161 of the second wiring unit 160 bundles and holds each of the four power input wirings 162 and each of the five sensor wirings 163 on the axially rear side in a form that they are arranged side by side in the same direction as the four connection parts of the power input part 120.

In the electric oil pump 1 having such a configuration, the five sensor wirings 163 and the four power input wirings 162 are arranged on the axially rear side of the control board 101 in a simple wiring pattern that they do not intersect each other. Therefore, according to the electric oil pump 1, an increase in the size of the control board 101 in the thickness direction, resulting from the above-described wires intersecting each other on the axially rear side of the control board 101, is prevented.

(9) The motor power output part 121 of the electric oil pump 1 includes three individual output parts (sets of through holes and lands) that output power of three phases different from each other. The three individual output parts are arranged at the end on the axially front side of the control board 101 in a form of being arranged side by side in the same direction as the plurality of connection parts (lands and through holes) of the power input part 120. The sensor connection part of the control board 101 is arranged between the power input part 120 and the motor power output part 121 in the axial direction.

In the electric oil pump 1 having such a configuration, with respect to the flow of the power supply input to the power input part 120 of the control board 101 in the board 102, it is possible to adopt a board wiring pattern that realizes the following. That is, the board wiring pattern does not provide a route for returning from the axially front side to the rear side in the process of going from the power input part 120 to the motor power output part 121, or minimizes the route. Therefore, according to the electric oil pump 1, the size of the control board 101 is reduced (the area is reduced) by shortening the total length of the board wiring pattern.

(10) In the electric oil pump 1, the five connection parts (sets of through holes and lands) in the sensor connection part 122 of the control board 101 are arranged on the control board 101 in a form of being arranged side by side in the axial direction. The first wiring holder 161 of the second wiring unit 160 holds the five sensor wirings 163 on the axially front side in a form that they are arranged side by side in the thickness direction of the board 102 of the control board 101.

According to the electric oil pump 1 having such a configuration, by arranging the five connection parts in the sensor connection part 122 of the control board 101 side by side in the axial direction, the size of the control board 101 in the direction orthogonal to the axial direction is reduced.

Furthermore, in the electric oil pump 1, the first wiring holder 161 three-dimensionally holds the five sensor wirings 163 on the axially front side of the second wiring unit 160 in a form that they are arranged side by side in the thickness direction of the board 102. In such a configuration, the following is realized without using a configuration that bypasses any one of the five sensor wirings 163 in the board surface direction to avoid interference with other sensor wirings on the axially front side of the second wiring unit 160. That is, the electric oil pump 1 is able to connect the five sensor wirings 163 to the five connection parts arranged side by side in the axial direction of the sensor connection part 122 without using the above-described configuration. Therefore, according to the electric oil pump 1, the wiring pattern of the five sensor wirings 163 on the axially front side of the second wiring unit 160 is simplified.

(11) In the electric oil pump 1, the second capacitor 127, which has the largest size in the board thickness direction of the control board 101 among the electronic components mounted on the control board 101, is mounted on the first surface of the board 102 of the control board 101. The control board 101 is arranged in a position that the first surface faces the side of the motor part 10. The axially front side of the first wiring holder 161 of the second wiring unit 160 is arranged between the first surface and the motor part 10 in the radial direction.

In the electric oil pump 1 having such a configuration, a space (dead space) is generated between the first surface of the board 102 and the motor part 10 in a region where the second capacitor 127 having the largest thickness is not present. According to the electric oil pump 1, the size of the electric oil pump 1 is reduced by using the above-described region as the arrangement space for the five sensor wirings 163.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric oil pump, comprising:
a pump part;
a motor driving the pump part and comprising a rotor, a stator, and a motor shaft;
a housing housing the motor;
a control board comprising a drive circuit controlling driving of the motor; and
a sensor board equipped with a rotation sensor detecting a rotation angle of the rotor of the motor,
wherein the motor shaft has one axial side connected to the pump part,
the control board comprises a sensor connection part performing electrical connection with the sensor board,
the control board is arranged on a radially outer side with respect to the motor in a position of extending in an axial direction,
the sensor board is arranged on the other axial side with respect to the motor shaft, and is arranged in a direction intersecting the axial direction,
the sensor board is connected to a wiring module, and
the wiring module is arranged between the control board and the sensor board, and comprises a sensor signal line and a sensor drive power supply line, and holds the sensor signal line and the sensor drive power supply line.

2. The electric oil pump according to claim 1, wherein the wiring module comprises a first region extending in the axial direction, and a second region bent to a motor shaft side, and
the first region is arranged on the other axial side with respect to an end on the other axial side of the control board.

3. The electric oil pump according to claim 1, wherein the sensor board is arranged in a direction orthogonal to the axial direction.

4. The electric oil pump according to claim 1, wherein the wiring module is fixed to the housing.

5. The electric oil pump according to claim 1, wherein the wiring module is fixed to a bearing holder, and
the bearing holder holds a bearing that fits to the motor shaft.
